(19) United States
(12) Patent Application Publication
(10) Pub. No.: US 2009/0131573 A1
(43) Pub. Date: May 21, 2009

(54) PROCESS FOR THE PRODUCTION OF ALUMINUM HYDROXIDE

(75) Inventors: Rene Gabriel Erich Herbiet, Eupen (BE); Volker Ernst Willi Keller, Frechen (DE); Dagmar Linek, Koeln (DE); Winfried Toedt, Steffein-Auel (DE)

Correspondence Address: ALBEMARLE CORPORATION;PATENT DEPARTMENT, 451 FLORIDA STREET, BATON ROUGE, LA, 70801, US

(73) Assignee: Martinswerk GmbH, Bergheim (DE)

(21) Appl. No.: 12/304,609

(22) PCT Filed: Jun. 21, 2007
(86) PCT No.: PCT/IB2007/004405

§ 371 Date: Dec. 12, 2008

Related U.S. Application Data
(60) Provisional application No. 60/815,515, filed on Jun. 21, 2006.
(60) Provisional application No. 60/815,426, filed on Jun. 21, 2006.
(60) Provisional application No. 60/818,670, filed on Jul. 5, 2006.
(60) Provisional application No. 60/818,633, filed on Jul. 5, 2006.
(60) Provisional application No. 60/818,632, filed on Jul. 5, 2006.
(60) Provisional application No. 60/828,912, filed on Oct. 10, 2006.
(60) Provisional application No. 60/828,908, filed on Oct. 10, 2006.
(60) Provisional application No. 60/828,977, filed on Oct. 11, 2006.
(60) Provisional application No. 60/828,901, filed on Oct. 10, 2006.
(60) Provisional application No. 60/889,327, filed on Feb. 12, 2007.
(60) Provisional application No. 60/889,330, filed on Feb. 12, 2007.
(60) Provisional application No. 60/889,325, filed on Feb. 12, 2007.
(60) Provisional application No. 60/889,316, filed on Feb. 12, 2007.
(60) Provisional application No. 60/889,320, filed on Feb. 12, 2007.
(60) Provisional application No. 60/889,319, filed on Feb. 12, 2007.
(60) Provisional application No. 60/891,747, filed on Feb. 27, 2007.
(60) Provisional application No. 60/891,748, filed on Feb. 27, 2007.
(60) Provisional application No. 60/891,745, filed on Feb. 27, 2007.
(60) Provisional application No. 60/891,746, filed on Feb. 27, 2007.
(60) Provisional application No. 60/916,477, filed on May 7, 2007.

(51) Int. Cl. C08K 3/22; C01F 7/02

(52) U.S. Cl. 524/437; 423/629

(57) ABSTRACT

The present invention relates to a novel process for the production of aluminum hydroxide flame retardants having improved thermal stability, the aluminum hydroxide particles produced therefrom, the use of the aluminum hydroxide particles produced therefrom in flame retarded polymer formulations, and molded or extruded articles made from the flame retarded polymer formulations.

### FIELD OF THE INVENTION

The present invention relates to the production of mineral flame retardants. More particularly the present invention relates to a novel process for the production of aluminum hydroxide flame retardants.

### BACKGROUND OF THE INVENTION

Aluminum hydroxide has a variety of alternative names such as aluminum hydrate, aluminum trihydrate, aluminum trihydroxide, etc., but it is commonly referred to as ATH. Particulate aluminum hydroxide, hereinafter ATH, finds many uses as a filler in many materials such as, for example, papers, resins, rubber, plastics etc. One of the most prevalent uses of ATH is as a flame retardant in synthetic resins such as plastics and wire and cable.

The industrial applicability of ATH has been known for some time. In the flame retardant area, ATH particles are used in synthetic resins such as plastics and in wire and cable applications to impart flame retardant properties. The compounding performance and viscosity of the synthetic resin containing the ATH particles is a critical attribute that is linked to the ATH particles. In the synthetic resin industry, the demand for better compounding performance has increased for obvious reasons.

Thus, as the demand for better compounding performance increases, there exists a need in the art for methods of producing ATH particles that meet these demands.

### BRIEF DESCRIPTION OF THE FIGURES

FIG. 1 shows the specific pore volume V as a function of the applied pressure for the second intrusion test run and an ATH according to the present invention (“Inventive”), in comparison with standard grades.

FIG. 2 shows the specific pore volume V plotted against the pore radius r for the second intrusion test run and an ATE according to the present invention (“Inventive”), in comparison with standard grades.

FIG. 3 shows the normalized specific pore volume for an ATH according to the present invention (“Inventive”), in comparison with standard grades, the graph was generated with the maximum specific pore volume for each ATH grade set at 100%, and the other specific volumes of the corresponding ATH grade were divided by this maximum value.

FIG. 4 shows the power draw on the motor of a discharge extruder for the inventive aluminum hydroxide grade produced in Example 1 and used in Example 2.

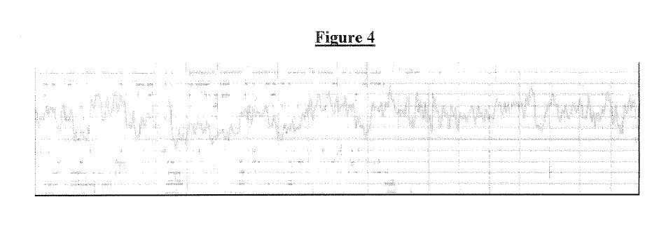

FIG. 5 shows the power draw on the motor of a discharge extruder for the comparative aluminum hydroxide grade OL-104 LE.

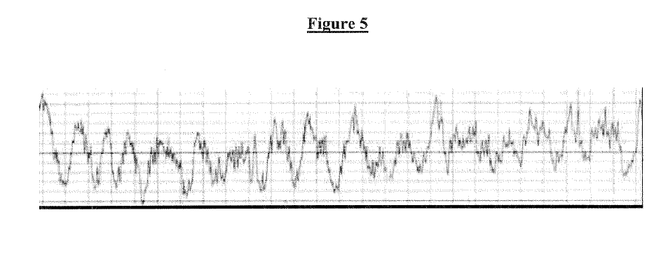

### SUMMARY OF THE INVENTION

The present invention relates to a process for producing dry-milled ATH. The process generally comprises:
a) spray drying an aluminum hydroxide slurry or filter cake to produce spray-dried aluminum hydroxide particles; and
b) dry milling said spray dried aluminum hydroxide particles thus producing dry-milled ATH particles,
   wherein the dry-milled ATH has a median pore radius (“r₅₀”) in the range of from about 0.09 to about 0.33 μm and
i) a BET specific surface area of from about 3 to about 6 m²/g; and
   a maximum specific pore volume at about 1000 bar of from about 390 to about 480 m³/g;

or
ii) a BET specific surface area of from about 6 to about 9 m²/g; and
   a maximum specific pore volume at about 1000 bar of from about 400 to about 600 mm³/g

or
iii) a BET specific surface area of from about 9 to about 15 m²/g; and
   a maximum specific pore volume at about 1000 bar of from about 300 to about 700 mm³g.

In another embodiment, the present invention relates to a process for producing dry-milled ATH. The process generally comprises:
a) spray drying an aluminum hydroxide slurry or filter cake to produce spray-dried aluminum hydroxide particles; and
b) dry milling said spray dried aluminum hydroxide particles thus producing dry-milled ATH particles,

wherein the dry-milled ATH particles have:
i) a BET specific surface area of from about 3 to about 6 m²/g; and

a maximum specific pore volume at about 1000 bar of from about 390 to about 480 mm³/g;

or
ii) a BET specific surface area of from about 6 to about 9 m²/g, and
   a maximum specific pore volume at about 1000 bar of from about 400 to about 600 mm³/g

or
iii) a BET specific surface area of from about 9 to about 15 m²/g; and
   a maximum specific pore volume at about 1000 bar of from about 300 to about 700 mm³/g.

### DETAILED DESCRIPTION OF THE INVENTION

The wettability of ATH particles with resins depends on the morphology of the ATH particles, and the inventors hereof have unexpectedly discovered that by using the process of the present invention, ATH particles having an improved wettability in relation to ATH particles currently available can be produced. While not wishing to be bound by theory, the inventors hereof believe that this improved wettability is attributable to an improvement in the morphology of the ATH particles produced by the process disclosed herein.

### Slurry and Filter Cake

In one embodiment of the present invention a slurry or a filter cake containing ATH particles is spray dried to produce spray dried ATH particles which are then dry milled, thus producing dry milled ATH particles. In one preferred embodiment, a slurry is spray-dried and in another preferred embodiment, a filter cake is spray-dried.

The slurry or the filter cake typically contains in the range of from about 1 to about 85 wt. % ATH particles, based on the total weight of the slurry or the filter cake. In preferred embodiments, the slurry or the filter cake contains in the range of from about 25 to about 70 wt. % ATH particles, more preferably in the range of from about 55 to about 65 wt. % ATH particles, both on the same basis. In other preferred embodiments, the slurry or the filter cake contains in the range of from about 40 to about 60 wt. % ATH particles, more preferably in the range of from about 45 to about 55 wt. % ATH particles, both on the same basis. In still other preferred embodiments, the slurry or the filter cake contains in the range of from about 25 to about 50 wt. % ATH particles, more preferably in the range of from about 30 to about 45 wt. % ATH particles, both on the same basis.

The slurry or the filter cake used in the practice of the present invention can be obtained from any process used to produce ATH particles. Preferably the slurry or the filter cake is obtained from a process that involves producing ATH particles through precipitation and filtration. In an exemplary embodiment, the slurry or the filter cake is obtained from a process that comprises dissolving crude aluminum hydroxide in caustic soda to form a sodium aluminate liquor, which is cooled and filtered thus forming a sodium aluminate liquor useful in this exemplary embodiment. The sodium aluminate liquor thus produced typically has a molar ratio of Na₂O to Al₂O₃ in the range of from about 1.4:1 to about 1.55:1. In order to precipitate ATH particles from the sodium aluminate liquor, ATH seed particles are added to the sodium aluminate liquor in an amount in the range of from about 1 g of ATH seed particles per liter of sodium aluminate liquor to about 3 g of ATH seed particles per liter of sodium aluminate liquor thus forming a process mixture. The ATH seed particles are added to the sodium aluminate liquor when the sodium aluminate liquor is at a liquor temperature of from about 45 to about 80° C. After the addition of the ATH seed particles, the process mixture is stirred for about 100 h or alternatively until the molar ratio of Na₂O to Al₂O₃ is in the range of from about 2.2:1 to about 3.5:1, thus forming an ATH suspension. The obtained ATH suspension typically comprises from about 80 to about 160 g/l ATM, based on the suspension. However, the ATH concentration can be varied to fall within the ranges described above, The obtained ATH suspension is then filtered and washed to remove impurities therefrom, thus forming a filter cake. The filter cake can be washed one, or in some embodiments more than one, times with water, preferably de-salted water. This filter cake can then be directly spray dried.

However, in some preferred embodiments, the filter cake can be re-slurried with water to form a slurry, or in a preferred embodiment, at least one, preferably only one, dispersing agent is added to the filter cake to form a slurry having an ATH concentration in the above-described ranges. It should be noted that it is also within the scope of the present invention to re-slurry the filter cake with a combination of water and a dispersing agent. Non-limiting examples of dispersing agents suitable for use herein include polyacrylates, organic acids, naphtalensulfonate/formaldehyde condensate, fatty-alcohol-polyglycol-ether, polypropylene-ethylenoxid, polyglycol-ester, polyamine-ethylenoxid, phosphate, polyvinylalcohole. If the slurry comprises a dispersing agent, the slurry may contain up to about 80%. % ATH, based on the total weight of the slurry, because of the effects of the dispersing agent. In this embodiment, the remainder of the slurry or the filter cake (i.e. not including the ATH particles and the dispersing agent(s)) is typically water, although some reagents, contaminants, etc. may be present from precipitation.

The ATH particles in the slurry or the filter cake are generally characterized as having a BET in the range of from about 1.0 to about 4.0 m²/g. In preferred embodiments, the ATH particles have a BET in the range of from about 1.5 to about 2.5 m²/g. The ATH particles in the slurry or the filter cake can be further characterized as having a d₅₀ in the range of from about 2.0 to about 3.5 μm. In preferred embodiments, the ATH particles in the slurry or the filter cake have a d₅₀ in the range of from about 1.8 to about 2.5 μm, which is coarser than the dry milled ATH particles produced by the present invention. In other preferred embodiments, the ATH particles in the slurry or the filter cake are characterized as having a BET in the range of from about 4.0 to about 8.0 m²/g. In other preferred embodiments, the ATH particles in the slurry or the filter cake have a BET in the range of from about 5 to about 7 m²/g. In this embodiment, the ATH particles in the slurry or the filter cake can be further characterized as having a d₅₀ in the range of from about 1.5 to about 2.5 μm. In still other preferred embodiments, the ATH particles in the slurry or the filter cake have a d₅₀ in the range of from about 1.6 to about 2.0 μm, which is coarser than the dry milled ATH particles produced by the present invention. In still other preferred embodiments, the ATH particles in the slurry or the filter cake are characterized as having a BET in the range of from about 8.0 to about 14 m²/g. In still other preferred embodiments, the ATH particles in the slurry or the filter cake have a BET in the range of from about 9 to about 12 m²/g. The ATH particles in the slurry or the filter cake in these preferred embodiments can be further characterized as having a d₅₀ in the range of from about 1.5 to about 2.0 μm. In preferred embodiments, the ATH particles in the slurry or the filter cake have a d₅₀ in the range of from about 1.5 to about 1.8 μm, which is coarser than the dry milled ATH particles produced by the present invention.

By coarser than the dry milled ATH particles, it is meant that the upper limit of the d₅₀ value of the ATH particles in the slurry or the filter cake is generally at least about 0.2 μm higher than the upper limit of the d₅₀ of the dry milled ATH particles produced by the present invention.

The inventors hereof, while not wishing to be bound by theory, believe that the improved morphology of the ATH particles produced by the present invention is at least partially attributable to the process used to precipitate the ATH. Thus, while dry milling techniques are known in the art, the inventors hereof have discovered that by using the precipitation and filtration processes described herein, including preferred embodiments, along with the dry milling process described herein, ATH particles having improved morphology, as described below, can be readily produced.

### Spray-Drying

Spray drying is a technique that is commonly used in the production of aluminum hydroxide. This technique generally involves the atomization of an ATH feed, here the milled ATH slurry or the filter cake, through the use of nozzles and/or rotary atomizers. The atomized feed is then contacted with a hot gas, typically air, and the spray dried ATH is then recovered from the hot gas stream. The contacting of the atomized feed can be conducted in either a counter or co-current fashion, and the gas temperature, atomization, contacting, and flow rates of the gas and/or atomized feed can be controlled to produce ATH particles having desired product properties.

The recovery of the spray dried ATH can be achieved through the use of recovery techniques such as filtration or just allowing the spray-dried particles to fall to collect in the spray drier where they can be removed, but any suitable recovery technique can be used. In preferred embodiments, the spray dried ATH is recovered from the spray drier by allowing it to settle, and screw conveyors recover it from the spray-drier and subsequently convey through pipes into a silo by means of compressed air.

The spray-drying conditions are conventional and are readily selected by one having ordinary skill in the art with knowledge of the desired ATH particle product qualities, described below. Generally, these conditions include inlet air temperatures between typically 250 and 550° C. and outlet air temperatures typically between 105 and 150° C.

### Dry-Milling

By dry-milling, it is meant that the spray-dried ATH is subjected to a further treatment wherein the ATH is de-agglomerated with little reduction in the particle size of the spray-dried ATH. By “little particle size reduction” it is meant that the d₅₀ of the dry-milled ATH is in the range of from about 40% to about 90% of the ATH in the slurry or the filter cake prior to spray drying. In preferred embodiments, the d₅₀ of the dry-milled ATH is in the range of from about 60% to about 80% of the ATH in the slurry or the filter cake prior to spray drying, more preferably within the range of from about 70% to about 75% of the ATH in the slurry or the filter cake prior to spray drying.

The mill used in dry-milling the spray dried ATH can be selected from any dry-mills known in the art. Non-limiting examples of suitable dry mills include ball or media mills, cone and gyratory crushers, disk attrition mills, colloid and roll mills, screen mills and granulators, hammer and cage mills, pin and universal mills, impact mills and breakers, jaw crushers, jet and fluid energy mills, roll crushers, disc mills, and vertical rollers and dry pans, vibratory mills.

The dry-milled ATH recovered from the dry-milling of the spray-dried ATH can be classified via any classification techniques known because during dry milling, agglomerates can be produced, depending on the mill used. Non-limiting examples of suitable classification techniques include air classification. It should be noted that some mills have a built-in air classifier; if this is not the case, a separate air classifier can be used. If a pin mill is not used in the dry-milling, the dry-milled ATH can be subjected to further treatment in one or more pin mills.

The dry-milling of the spray-dried ATH is conducted under conditions effective at producing a dry-milled ATH having an improved morphology, discussed below.

### Improved Morphology Dry-Milled ATH

In general, the process of the present invention can be used to produce dry-milled ATH particles having many different properties. Generally, the process can be used to produce dry-milled dried ATH particles having an oil absorption, as determined by ISO 787-5:1980 of in the range of from about 1 to about 35%, a BET specific surface area, as determined by DIN-66132, in the range of from about 1 to 15 m²/g, and a d₅₀ in the range of from about 0.5 to 2.5 μm.

However, the process of the present invention is especially well-suited to produce dry-milled ATH particles having an improved morphology when compared with currently available ATH. Again, while not wishing to be bound by theory, the inventors hereof believe that this improved morphology is attributable to the total specific pore volume and/or the median pore radius (“r₅₀”) of the dry-milled ATH particles. The inventors hereof believe that, for a given polymer molecule, an ATH having a higher structured aggregate contains more and bigger pores and seems to be more difficult to wet, leading to difficulties (higher variations of the power draw on the motor) during compounding in kneaders like Buss Ko-kneaders or twin-screw extruders or other machines known in the art and used to this purpose. Therefore, the inventors hereof have discovered that the process of the present invention produces dry-milled ATH particles characterized by smaller median pore sizes and/or lower total pore volumes, which correlates with an improved wetting with polymeric materials and thus results in improved compounding behavior, i.e. less variations of the power draw of the engines (motors) of compounding machines used to compound a flame retarded resin containing the dry-milled ATH filler.

The r₅₀ and the Vₘₐₓ of the dry-milled ATH particles particles produced by the present invention can be derived from mercury porosimetry. The theory of mercury porosimetry is based on the physical principle that a non-reactive, non-wetting liquid will not penetrate pores until sufficient pressure is applied to force its entrance. Thus, the higher the pressure necessary for the liquid to enter the pores, the smaller the pore size. A smaller pore size and/or a lower total specific pore volume were found to correlate to better wettability of the dry-milled ATH particles produced by the present invention. The pore size of the dry-milled ATH particles produced by the present invention can be calculated from data derived from mercury porosimetry using a Porosimeter 2000 from Carlo Erba Strumentazione, Italy. According to the manual of the Porosimeter 2000, the following equation is used to calculate the pore radius r from the measured pressure p: r=−2 γ cos(θ)/p; wherein θ is the wetting angle and γ is the surface tension. The measurements taken herein used a value of 141.3° for θ and γ was set to 480 dyn/cm.

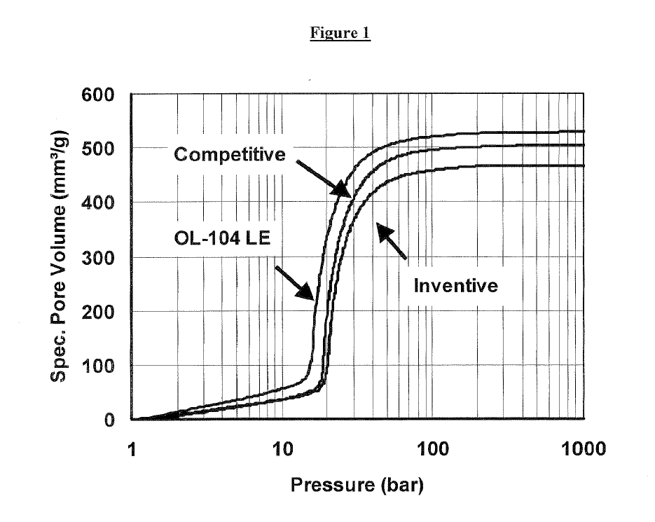

In order to improve the repeatability of the measurements, the pore size of the ATH particles was calculated from the second ATH intrusion test run, as described in the manual of the Porosimeter 2000. The second test run was used because the inventors observed that an amount of mercury having the volume V₀ remains in the sample of the ATH particles after extrusion, i.e. after release of the pressure to ambient pressure. Thus, the r₅₀ can be derived from this data as explained below with reference to FIGS. 1, 2, and 3.

In the first test run, a sample of dry-milled ATH particles produced by the present invention was prepared as described in the manual of the Porosimeter 2000, and the pore volume was measured as a function of the applied intrusion pressure p using a maximum pressure of about 1000 bar, The pressure was released and allowed to reach ambient pressure upon completion of the first test run. A second intrusion test run (according to the manual of the Porosimeter 2000) utilizing the same ATH sample, unadulterated, from the first test run was performed, where the measurement of the specific pore volume V(p) of the second test run takes the volume V₀ as a new starting volume, which is then set to zero for the second test run.

In the second intrusion test run, the measurement of the specific pore volume V(p) of the ATH sample was again performed as a function of the applied intrusion pressure using a maximum pressure of about 1000 bar. FIG. 1 shows the specific pore volume V as a function of the applied pressure for the second intrusion test run and an ATH grade, produced according to the present invention in comparison with current commercially available ATH products. The pore volume at about 1000 bar, i.e. the maximum pressure used in the measurement, is referred to as Vₘₐₓ herein.

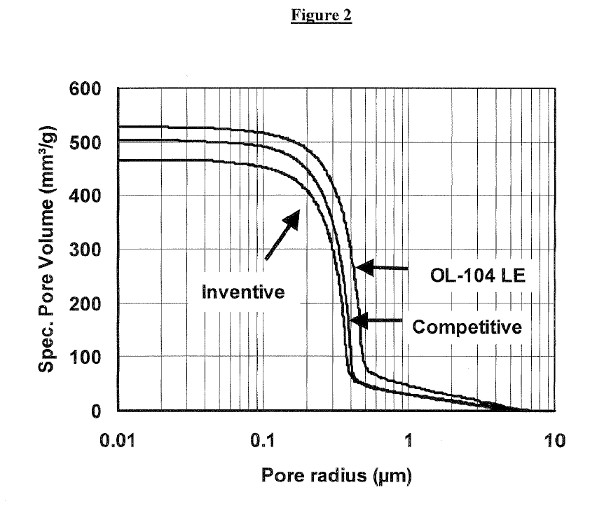

From the second ATH intrusion test run, the pore radius r was calculated by the Porosimeter 2000 according to the formula r=−2 γ cos(θ)/p; wherein θ is the wetting angle, γ is the surface tension and p the intrusion pressure. For all r-measurements taken herein, a value of 141.3° for θ was used and γ was set to 480 dyn/cm. The specific pore volume can thus be plotted against the pore radius r. FIG. 2 shows the specific pore volume V of the second intrusion test run (using the same sample) plotted against the pore radius r.

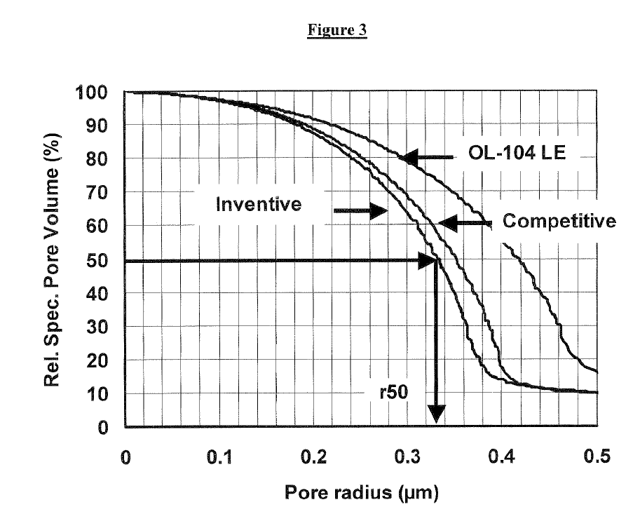

FIG. 3 shows the normalized specific pore volume of the second intrusion test run plotted against the pore radius r, i.e. in this curve, the maximum specific pore volume at 1000 bar of the second intrusion test run, Vₘₐₓ, was set to 100% and the other specific volumes for that particular ATH were divided by this maximum value. The pore radius at 50% of the relative specific pore volume, by definition, is called median pore radius r₅₀ herein. For example, according to FIG. 3, the median pore radius r₅₀ for an ATH according to the present invention, i.e. Inventive, is 0.33 μm.

The procedure described above was repeated using samples of ATH particles produced according to the present invention, and the dry-milled ATH particles produced by the present invention were found to have an r₅₀, i.e. a pore radius at 50% of the maximum specific pore volume, in the range of from about 0.09 to about 0.33 μm. In preferred embodiments of the present invention, the r₅₀ of the dry-milled ATH particles produced by the present invention is in the range of from about 0.20 to about 0.33 μm, more preferably in the range of from about 0.2 to about 0.3 μm. In other preferred embodiments, the r₅₀ is in the range of from about 0.185 to about 0.325 μm, more preferably in the range of from about 0.185 to about 0.25 μm. In still other preferred embodiments, the r₅₀ is in the range of from about 0.09 to about 0.21 μm, more preferably in the range of from about 0.09 to about 0.165 μm.

The dry-milled ATH particles produced by the present invention can also be characterized as having a Vₘₐₓ, i.e. maximum specific pore volume at 1000 bar, in the range of from about 300 to about 700 mm³/g. In preferred embodiments of the present invention, the Vₘₐₓ of the dry-milled ATH particles produced by the present invention is in the range of from about 390 to about 480 mm³/g, more preferably in the range of from about 410 to about 450 mm³/g. In other preferred embodiments, the Vₘₐₓ is in the range of from about 400 to about 600 mm³/g, more preferably in the range of from about 450 to about 550 mm³/g. In yet other preferred embodiments, the Vₘₐₓ is in the range of from about 300 to about 700 mm³/g, more preferably in the range of from about 350 to about 550 mm³/g.

The dry-milled ATH particles produced by the present invention can also be characterized as having an oil absorption, as determined by ISO 787-5:1980 of in the range of from about 1 to about 35%. In some preferred embodiments, the dry-milled ATH particles produced by the present invention are characterized as having an oil absorption in the range of from about 23 to about 30%, more preferably in the range of from about 25% to about 28%. In other preferred embodiments, the dry-milled ATH particles produced by the present invention are characterized as having an oil absorption in the range of from about 25% to about 32%, more preferably in the range of from about 26% to about 30%. In yet other preferred embodiments, the dry-milled ATH particles produced by the present invention are characterized as having an oil absorption in the range of from about 25 to about 35% more preferably in the range of from about 27% to about 32%. In other embodiments, the oil absorption of the dry-milled ATH particles produced by the present invention are in the range of from about 19% to about 23%, and in still other embodiments, the oil absorption of the dry-milled ATH particles produced by the present invention is in the range of from about 21% to about 25%.

The dry-milled ATH particles produced by the present invention can also be characterized as having a BET specific surface area, as determined by DIN-66132, in the range of from about 1 to 15 m²/g. In preferred embodiments, the dry-milled ATH particles produced by the present invention have a BET specific surface in the range of from about 3 to about 6 m²/g, more preferably in the range of from about 3.5 to about 5.5 m²/g. In other preferred embodiments, the dry-milled ATH particles produced by the present invention have a BET specific surface of in the range of from about 6 to about 9 m²/g, more preferably in the range of from about 6.5 to about 8.5 m²/g. In still other preferred embodiments, the dry-milled ATH particles produced by the present invention have a BET specific surface in the range of from about 9 to about 15 m²/g, more preferably in the range of from about 10.5 to about 12.5 m²/g.

The dry-milled ATH particles produced by the present invention can also be characterized as having a d₅₀ in the range of from about 0.5 to 2.5 μm. In preferred embodiments, the dry-milled ATH particles produced by the present invention have a d₅₀ in the range of from about 115 to about 2.5 μm, more preferably in the range of from about 1.8 to about 2.2 μm. In other preferred embodiments, the dry-milled ATH particles produced by the present invention have a d₅₀ in the range of from about 1.3 to about 2.0 μm, more preferably in the range of from about 1.4 to about 1.8 μm. In still other preferred embodiments, the dry-milled ATH particles produced by the present invention have a d₅₀ in the range of from about 0.9 to about 1.8 μm, more preferably in the range of from about 1.1 to about 1.5 μm.

It should be noted that all particle diameter measurements, i.e. d₅₀, disclosed herein were measured by laser diffraction using a Cilas 1064 L laser spectrometer from Quantachrome. Generally, the procedure used herein to measure the d₅₀, can be practiced by first introducing a suitable water-dispersant solution (preparation see below) into the sample-preparation vessel of the apparatus. The standard measurement called “Particle Expert” is then selected, the measurement model “Range 1” is also selected, and apparatus-internal parameters, which apply to the expected particle size distribution, are then chosen. It should be noted that during the measurements the sample is typically exposed to ultrasound for about 60 seconds during the dispersion and during the measurement. After a background measurement has taken place, from about 75 to about 100 mg of the sample to be analyzed is placed in the sample vessel with the water/dispersant solution and the measurement started. The water/dispersant solution can be prepared by first preparing a concentrate from 500 g Calgon, available from KMF Laborchemie, with 3 liters of CAL Polysalt, available from BASF. This solution is made up to 10 liters with deionized water. 100 ml of this original 10 liters is taken and in turn diluted further to 10 liters with deionized water, and this final solution is used as the water-dispersant solution described above.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, when discussing the Vₘₐₓ of the dry-milled ATH, the Vₘₐₓ can include values in the range of from about 450 to about 490 mm³/g, in the range of from about 550 to about 700 mm³/g, in the range of from about 390 to about 410 mm³/g, etc. The following examples will illustrate the present invention, but are not meant to be limiting in any manner.

### EXAMPLES

The r₅₀ and Vₘₐₓ described in the examples below was derived from mercury porosimetry using a Porosimeter 2000, as described above. All d₅₀, BET, oil absorption, etc., unless otherwise indicated, were measured according to the techniques described above. Also, the terms “inventive aluminum hydroxide grade”, “Inventive” and “inventive filler” as used in the examples is meant to refer to an ATH produced according to the present invention, and “Comparative aluminum hydroxide grade”, “Competitive”, and “Comparative” is meant to refer to an ATH that is commercially available and not produced according to the present invention.

### Example 1

In order to form a slurry, suitable amounts of the dispersing agent Antiprex® A40, available commercially from Ciba®, was added to an ATH filter cake, which had a solid content of 55 wt. %, thus forming a slurry having a viscosity of about 150 cPoise. In the slurry, i.e. prior to spray drying, the aluminum hydroxide had a BET specific surface of 2.3 m²/g and a d₅₀ of 2.48 μm. The slurry was then spray dried by means of a Niro F100 spray drier, and the spray dried aluminum hydroxide was then fed into a jet mill, type SJ50-ER100, available commercially from PMT-Jetmill GmbH in Austria, and dry-milled. To this purpose, the integrated classifier rotor speed was set to 5200 rpm, and the milling pressure was set to 6.6 bar. These milling parameters resulted in a throughput of the aluminum hydroxide of 1066 kg/h, and the resulting milling temperature was 161° C. After dry-milling, the dry-milled ATH particles were collected from the hot air stream exiting the SJ50-ER100 via an air filter system. The product properties of the recovered dry-milled ATH particles (Inventive) are contained in Table 1, below.

The product properties of a comparative aluminum hydroxide grade, Martinal® OL-104 LE produced by Martinswerk GmbH, and another competitive aluminum hydroxide grade “Competitive” are also shown in Table 1.

TABLE 1

| | | Maximum | Median | Specific |
|---|---|---|---|---|
| | Median pore | specific pore | particle | BET |
| | radius (“r₅₀”) | volume Vₘₐₓ | size d₅₀ | surface |
| | (μm) | (mm³/g) | (μm) | (m²/g) |
| Comparative | 0.419 | 529 | 1.83 | 3.2 |
| ATH OL-104 LE | | | | |
| Competitive | 0.353 | 504 | 1.52 | 3.2 |
| Inventive | 0.33 | 440 | 1.93 | 3.7 |

As can be seen in Table 1, the inventive aluminum hydroxide grade, an ATH produced according to the present invention, has the lowest median pore radius and the lowest maximum specific pore volume.

### Example 2

The comparative aluminum hydroxide particles Martinal® OL-104 LE and the inventive aluminum hydroxide grade of Example 1 were separately used to form a flame-retardant resin formulation. The synthetic resin used was a mixture of EVA Escorene® Ultra UL00328 from ExxonMobil together with a LLDPE grade LL1001XV commercially available from ExxonMobil, Ethanox® 310 antioxidant available commercially from the Albemarle® Corporation, and an amino silane Dynasylan AMEO from Degussa. The components were mixed on a 46 mm Buss Ko-kneader (L/D ratio=11) at a throughput of 25 kg/h with temperature settings and screw speed chosen in a usual manner familiar to a person skilled in the art. The amount of each component used in formulating the flame-retardant resin formulation is detailed in Table 2, below.

TABLE 3

| | 1 wt. % TGA (° C.) | 2 wt. % TGA (° C.) |
|---|---|---|
| Typical | 195-210 | 205-220 |
| Preferred | 195-205 | 205-215 |
| More Preferred | 195-200 | 205-210 |

Thermal stability, as used herein, refers to release of water of the dry-milled ATH particles and can be assessed directly by several thermoanalytical methods such as thermogravimetric analysis (“TGA”), and in the present invention, the thermal stability of the dry-milled ATH particles was measured via TGA. Prior to the measurement, the dry-milled ATH particle samples were dried in an oven for 4 hours at about 105° C. to remove surface moisture. The TGA measurement was then performed with a Mettler Toledo by using a 70 μl alumina crucible (initial weight of about 12 mg) under N₂ (70 ml per minute) with the following heating rate: 30° C. to 150° C. at 10C per min, 150° C. to 350° C. at 1° C. per min, 350° C. to 600° C. at 10° C. per min. The TGA temperature of the dry-milled ATH particles (pre-dried as described above) was measured at 1 wt. % loss and 2 wt. % loss, both based on the weight of the dry-milled ATH particles. It should be noted that the TGA measurements described above were taken using a lid to cover the crucible.

The dry-milled ATH particles can also be characterized as having an electrical conductivity in the range of less than about 200 μS/cm, in some embodiments less than 150 μS/cm, and in other embodiments, less than 100 μS/cm. In other embodiments, the electrical conductivity of the dry-milled ATH particles is in the range of about 10 to about 45 μS/cm. It should be noted that all electrical conductivity measurements were conducted on a solution comprising water and about at 10 wt. % dry-milled ATH, based on the solution, as described below.

The electrical conductivity was measured by the following procedure using a MultiLab 540 conductivity measuring instrument from Wissenschaftlich-Technische-Werkstätten GmbH, Weilheim/Germany: 10 g of the sample to be analyzed and 90 ml deionized water (of ambient temperature) are shaken in a 100 ml Erlenmeyer flask on a GFL 3015 shaking device available from Gesellschaft for Labortechnik mbH, Burgwedel/Germany for 10 minutes at maximum performance. Then the conductivity electrode is immersed in the suspension and the electrical conductivity is measured.

The dry-milled ATH particles can also be characterized as having a soluble soda content of less than about 0.1 wt. %, based on the dry-milled ATH particles. In other embodiments, the dry-milled ATH particles can be further characterized as having a soluble soda content in the range of from greater than about 0.001 to about 0.1 wt. %, in some embodiments in the range of from about 0.02 to about 0.1 wt. %, both based on the dry-milled ATH particles. While in other embodiments, the dry-milled ATH particles can be further characterized as having a soluble soda content in the range of from about 0.001 to less than 0.03 wt %, in some embodiments in the range of from about 0.001 to less than 0.04 wt %, in other embodiments in the range of from about 0.001 to less than 0.02 wt %, all on the same basis. The soluble soda content can be measured according to the procedure outlined above.

The dry-milled ATH particles can be, and preferably are, characterized by the non-soluble soda content. While empirical evidence indicates that the thermal stability of an ATH is linked to the total soda content of the ATH, the inventors hereof have discovered and believe, while not wishing to be bound by theory, that the improved thermal stability of the dry-milled ATH particles produced by the process of the present invention is linked to the non-soluble soda content. The non-soluble soda content of the dry-milled ATH particles of the present invention is typically in the range of from about 70 to about 99.8% of the total soda content of the dry-milled ATH, with the remainder being soluble soda. In some embodiments of the present invention, the total soda content of the dry-milled ATH particles is typically in the range of less than about 0.20 wt. %, based on the dry-milled ATH, preferably in the range of less than about 0.18 wt. %, based on the dry-milled ATH, more preferably in the range of less than about 0.12 wt. %, on the same basis. In other embodiments of the present invention, the total soda content of the dry-milled ATH particles is typically in the range of less than about 0.30 wt. %, based on the dry-milled ATH, preferably in the range of less than about 0.25 wt. %, based on the dry-milled ATH, more preferably in the range of less than about 0.20 wt. %, on the same basis. In still other embodiments of the present invention, the total soda content of the dry-milled ATH particles is typically in the range of less than about 0.40 wt. %, based on the dry-milled ATH, preferably in the range of less than about 0.30 wt. %, based on the dry-milled ATH, more preferably in the range of less than about 0.25 wt. %, on the same basis.

### Use of the Dry-Milled ATH

The dry-milled ATH particles according to the present invention can be used as a flame retardant in a variety of synthetic resins. Thus, in one embodiment, the present invention relates to a flame retarded polymer formulation comprising at least one synthetic resin, in some embodiments only one, and a flame retarding amount of dry-milled ATH particles according to the present invention, and molded and/or extruded articles made from the flame retarded polymer formulation.

By a flame retarding amount of the dry-milled ATH particles, it is generally meant in the range of from about 5 wt % to about 90 wt %, based on the weight of the flame retarded polymer formulation, preferably in the range of from about 20 wt % to about 70 wt %, on the same basis. In a most preferred embodiment, a flame retarding amount is in the range of from about 30 wt % to about 65 wt % of the dry-milled ATH particles, on the same basis. Thus, the flame retarded polymer formulation typically comprises in the range of from about 10 to about 95 wt. % of the at least one synthetic resin, based on the weight of the flame retarded polymer formulation, preferably in the range of from about 30 to about 40 wt. % of the flame retarded polymer formulation, more preferably in the range of from about 35 to about 70 wt. % of the at least one synthetic resin, all on the same basis.

Non-limiting examples of thermoplastic resins where the ATH particles find use include polyethylene, ethylene-propylene copolymer, polymers and copolymers of C₂ to C₈ olefins (α-olefin) such as polybutene, poly(4-methylpentene-1) or the like, copolymers of these olefins and diene, ethylene-acrylate copolymer, polystyrene, ABS resin, AAS resin, AS resin, MBS resin, ethylene-vinyl chloride copolymer resin, ethylene-vinyl acetate copolymer resin, ethylene-vinyl chloride-vinyl acetate graft polymer resin, vinylidene chloride, polyvinyl chloride, chlorinated polyethylene, vinyl chloride-propylene copolymer, vinyl acetate resin, phenoxy resin, and the like. Further examples of suitable synthetic resins include thermosetting resins such as epoxy resin, phenol resin, melamine resin, unsaturated polyester resin, alkyd resin and urea resin and natural or synthetic rubbers such as EPDM, butyl rubber, isoprene rubber, SBR, NIR, urethane rubber, polybutadiene rubber, acrylic rubber, silicone rubber, fluoro-elastomer, NBR and chloro-sulfonated polyethylene are also included, Further included are polymeric suspensions (latices).

Preferably, the synthetic resin is a polyethylene-based resins such as high-density polyethylene, low-density polyethylene, linear low-density polyethylene, ultra low-density polyethylene, EVA (ethylene-vinyl acetate resin), EEA (ethylene-ethyl acrylate resin), EMA (ethylene-methyl acrylate copolymer resin), EAA (ethylene-acrylic acid copolymer resin) and ultra high molecular weight polyethylene; and polymers and copolymers of C₂ to C₈ olefins (α-olefin) such as polybutene and poly(4-methylpentene-1), polyvinyl chloride and rubbers. In a more preferred embodiment, the synthetic resin is a polyethylene-based resin.

The flame retarded polymer formulation can also contain other additives commonly used in the art. Non-limiting examples of other additives that are suitable for use in the flame retarded polymer formulations of the present invention include extrusion aids such as polyethylene waxes, Si-based extrusion aids, fatty acids; coupling agents such as amino-, vinyl- or alkyl silanes or maleic acid grafted polymers; barium stearate or calcium sterate; organoperoxides; dyes; pigments; fillers; blowing agents; deodorants; thermal stabilizers; antioxidants; antistatic agents; reinforcing agents; metal scavengers or deactivators; impact modifiers; processing aids; mold release aids, lubricants; anti-blocking agents; other flame retardants; UV stabilizers; plasticizers; flow aids; and the like. If desired, nucleating agents such as calcium silicate or indigo can be included in the flame retarded polymer formulations also. The proportions of the other optional additives are conventional and can be varied to suit the needs of any given situation.

The methods of incorporation and addition of the components of the flame-retarded polymer formulation and the method by which the molding is conducted is not critical to the present invention and can be any known in the art so long as the method selected involves uniform mixing and molding. For example, each of the above components, and optional additives if used, can be mixed using a Buss Ko-kneader, internal mixers, Farrel continuous mixers or twin screw extruders or in some cases also single screw extruders or two roll mills, and then the flame retarded polymer formulation molded in a subsequent processing step. Further, the molded article of the flame-retardant polymer formulation may be used after fabrication for applications such as stretch processing, emboss processing, coating, printing, plating, perforation or cutting. The kneaded mixture can also be inflation-molded, injection-molded, extrusion-molded, blow-molded, press-molded, rotation-molded or calender-molded.

In the case of an extruded article, any extrusion technique known to be effective with the synthetic resin(s) used in the flame retarded polymer formulation can be employed. In one exemplary technique, the synthetic resin, dry-milled ATH particles, and optional components, if chosen, are compounded in a compounding machine to form the flame-retardant resin formulation. The flame-retardant resin formulation is then heated to a molten state in an extruder, and the molten flame-retardant resin formulation is then extruded through a selected die to form an extruded article or to coat for example a metal wire or a glass fiber used for data transmission.

In some embodiments, the synthetic resin is selected from epoxy resins, novolac resins, phosphorous containing resins like DOPO, brominated epoxy resins, unsaturated polyester resins and vinyl esters. In this embodiment, a flame retarding amount of dry-milled ATH particles is in the range of from about 5 to about 200 parts per hundred resins (“phr”) of the ATH. In preferred embodiments, the flame retarded formulation comprises from about 15 to about 100 phr preferably from about 15 to about 75 phr, more preferably from about 20 to about 55 phr, of the dry-milled ATH particles. In this embodiment, the flame retarded polymer formulation can also contain other additives commonly used in the art with these particular resins. Non-limiting examples of other additives that are suitable for use in this flame retarded polymer formulation include other flame retardants based e.g. on bromine, phosphorous or nitrogen; solvents, curing agents like hardeners or accelerators, dispersing agents or phosphorous compounds, fine silica, clay or talc. The proportions of the other optional additives are conventional and can be varied to suit the needs of any given situation. The preferred methods of incorporation and addition of the components of this flame retarded polymer formulation is by high shear mixing, For example, by using shearing a head mixer manufactured for example by the Silverson Company. Further processing of the resin-filler mix to the “prepreg” stage and then to the cured laminate is common state of the art and described in the literature, for example in the “Handbook of Epoxide Resins”, published by the McGraw-Hill Book Company, which is incorporated herein in its entirety by reference.

The above description is directed to several embodiments of the present invention. Those skilled in the art will recognize that other means, which are equally effective, could be devised for carrying out the spirit of this invention. It should also be noted that preferred embodiments of the present invention contemplate that all ranges discussed herein include ranges from any lower amount to any higher amount. For example, when discussing the oil absorption of the dry-milled ATH, it is contemplated that ranges from about 30% to about 32%, about 19% to about 25%, about 21% to about 27%, etc. are within the scope of the present invention.

1-23. (canceled)

24. A process for producing dry-milled ATH particles comprising:
a) spray drying an aluminum hydroxide slurry or filter cake containing in the range of from about 1 to about 85 wt. % ATH, based on the total weight of the slurry and/or filter cake, to produce spray-dried aluminum hydroxide particles; and
b) dry milling said spray dried aluminum hydroxide particles thus producing dry-milled ATH particles,
wherein the dry-milled ATH particles have a Vₘₐₓ in the range of from about 300 to about 700 mm³/g and/or an r₅₀ in the range of from about 0.09 to about 0.33 μm, and one or more of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water;
wherein said slurry or filter cake is obtained from a process that involves producing ATH particles through precipitation and filtration; and/or wherein said slurry or filter cake is obtained from a process that comprises dissolving aluminum hydroxide in caustic soda to form a sodium aluminate liquor; filtering the sodium aluminate solution to remove impurities; cooling and diluting the sodium aluminate liquor to an appropriate temperature and concentration; adding ATH seed particles to the sodium aluminate solution; allowing ATH particles to precipitate from the solution thus forming an ATH Suspension containing in the range of from about 80 to about 160 g/l ATH, based on the suspension; filtering the ATH suspension thus forming said filter cake, and optionally washing said filter cake one or more times with water before it is spray dried.

25. The process according to claim 24 wherein said slurry or filter cake is obtained from a process that comprises dissolving aluminum hydroxide in caustic soda to form a sodium aluminate liquor; filtering the sodium aluminate solution to remove impurities; cooling and diluting the sodium aluminate liquor to an appropriate temperature and concentration; adding ATH seed particles to the sodium aluminate solution; allowing ATH particles to precipitate from the solution thus forming an ATH suspension containing in the range of from about 80 to about 160 g/l ATH, based on the suspension; filtering the ATH suspension thus forming a filter cake; optionally washing said filter cake one or more times with water before it is re-slurried; and re-slurrying said filter cake to form a slurry comprising in the range of from about 1 to about 85 wt. % ATH, based on the total weight of the slurry.

26. The process according to claim 24 wherein:
a) the BET of the ATH particles in the slurry or filter cake is a) in the range of from about 1.0 to about 4.0 m²/g or b) in the range of from about 4.0 to about 8.0 m²/g, or c) in the range of from about 8.0 to about 14 m²/g;
b) the ATH particles in the slurry or filter cake have a d₅₀ in the range of from about 1.5 to about 3.5 μm; or
c) combinations of a) and b).

27. The process according to claim 26 wherein said slurry or filter cake contains i) in the range of from about 1 to about 85 wt. % ATH particles; ii) in the range of from about 25 to about 70 wt. % ATH particles; iii) in the range of from about 55 to about 65 wt. % ATH particles; in the range of from about 40 to about 60 wt. % ATH particles; iv) in the range of from about 45 to about 55 wt. % ATH particles; v) in the range of from about 25 to about 50 wt. % ATH particles; or vi) in the range of from about 30 to about 45 wt. % ATH particles;
wherein all wt. % are based on the total weight of the slurry or the filter cake.

28. The process according to claim 27 wherein the ATH particles in the slurry or filter cake have:
a) a total soda content of less than about 0.2 wt. %, based on the ATH particles in the slurry or filter cake;
b) a soluble soda content of less than about 0.1 wt. %, based on the ATH particles in the slurry or filter cake;
c) a non-soluble soda content in the range of from about 70 to about 99.8% of the total soda content, with the remainder being soluble soda
d) combinations of a), b), and c).

29. The process according to claim 24 wherein said slurry or filter cake comprises a dispersing agent.

30. The process according to claim 28 wherein the dry-milled ATH particles have:
a) a soluble soda content of less than about 0.1 wt. %, based on the ATH particles in the slurry or filter cake;
b) a non-soluble soda content in the range of from about 70 to about 99.8% of the total soda content with the remainder being soluble soda; or
c) combinations of a) and b).

31. The process according to claim 24 wherein said dry-milled ATH particles are classified or treated in one or more pin mills.

32. The dry-milled ATH particles according to claim 24.

33. Dry-milled ATH particles having a Vₘₐₓ in the range of from about 300 to about 700 mm³/g and/or an r₅₀ in the range of from about 0.09 to about 0.33 μm, and one or more of the following characteristics: i) a d₅₀ of from about 0.5 to about 2.5 μm; ii) a total soda content of less than about 0.4 wt %, based on the total weight of the dry-milled ATH particles; iii) an oil absorption of less than about 50%, as determined by ISO 787-5:1980; and
iv) a specific surface area (BET) as determined by D1N-66132 of from about 1 to about 15 m²/g, wherein the electrical conductivity of the dry-milled ATH particles is less than about 200 μS/cm, measured in water at 10 wt. % of the ATH in water.

34. The dry-milled ATH particles according to claim 33 wherein said dry-milled ATH particles have an oil absorption in the range of from about 19 to about 23%.

35. The dry-milled ATH particles according to claim 33 wherein the dry-milled ATH particles have:
a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, a Vₘₐₓ in the range of from about 390 to about 480 mm³/g, a total soda content of less than about 0.2 wt. %, an electrical conductivity in the range of less than about 100 μS/cm, a soluble soda content in the range of from 0.001 to less than 0.02 wt %, based on the dry-milled ATH particles, a non-soluble soda content in the range of from about 70 to about 99.8% of the total soda content of the dry-milled ATH and a thermal stability, determined by thermogravimetric analysis, as described in Table 1:
TABLE 1

| 1 wt. % TGA (° C.) | 2 wt. % TGA (° C.) |
|---|---|
| 210-225 | 220-235 |

or
b) a BET in the range of from about 6 to about 9 m²/g, a d₅₀ in the range of from about 1.3 to about 2.0 μm, an oil absorption in the range of from about 25 to about 40%, an r₅₀ in the range of from about 0.185 to about 0.325 μm, a Vₘₐₓ in the range of from about 400 to about 600 mm³/g, a total soda content of less than about 0.3 wt. %, an electrical conductivity in the range of less than about 150 ES/cm, a soluble soda content in the range of from 0.001 to less than 0.03 wt %, based on the dry-milled ATH particles, a non-soluble soda content in the range of from about 70 to about 99.8% of the total soda content of the dry-milled ATH and a thermal stability, determined by thermogravimetric analysis, as described in Table 2:
TABLE 2

| 1 wt. % TGA (° C.) | 2 wt. % TGA (° C.) |
|---|---|
| 200-215 | 210-225 |

or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, a Vₘₐₓ in the range of from about 300 to about 700 mm³/g, a total soda content of less than about 0.4 wt. %, an electrical conductivity in the range of less than about 200 μS/cm, a soluble soda content in the range of from 0.001 to less than 0.04 wt %, based on the dry-milled ATH particles, a non-soluble soda content in the range of from about 70 to about 99.8% of the total soda content of the dry-milled ATH and a thermal stability, determined by thermogravimetric analysis, as described in Table 3:
TABLE 3

| 1 wt. % TGA (° C.) | 2 wt. % TGA (° C.) |
|---|---|
| 195-210 | 205-220 |

36. The dry-milled particles according to claim 33 wherein said dry-milled ATH particles have:
a) a soluble soda content of less than about 0.1 wt. %, based on the ATH particles in the slurry or filter cake; or
b) a non-soluble soda content in the range of from about 70 to about 99 wt. % of the total soda content with the remainder being soluble soda; or
c) combinations of a) and b).

37. A flame retarded polymer formulation comprising at least one synthetic resin and in the range of from about 5 wt % to about 90 wt %, based on the weight of the flame retarded polymer formulation of the dry-milled ATH particles according to claim 36.

38. The flame retarded polymer formulation according to claim 37 wherein said dry-milled ATH particles having a Vₘₐₓ in the range of from about 300 to about 700 mm³/g and/or an r₅₀ in the range of from about 0.09 to about 0.33 μm, and one or more of the following characteristics: i) a d₅₀ of from about 0.5 to about 2.5 μm; ii) a total soda content of less than about 0.4 wt. %, based on the total weight of the dry-milled ATH particles; iii) an oil absorption of less than about 50%, as determined by ISO 787-5:1980; and iv) a specific surface area (BET) as determined by DIN-66132 of from about 1 to about 15 m²/g, wherein the electrical conductivity of the dry-milled ATH particles is less than about 200 μS/cm, measured in water at 10 wt. % of the ATH in water.

39. The flame retarded polymer formulation according to claim 38 wherein said dry-milled ATH particles have an oil absorption in the range of from about 19 to about 23%.

40. The flame retarded polymer formulation according to claim 38 wherein the dry-milled ATH particles have:
a) a BET in the range of from about 3 to about 6 m²/g, a d₅₀ in the range of from about 1.5 to about 2.5 μm, an oil absorption in the range of from about 23 to about 30%, an r₅₀ in the range of from about 0.2 to about 0.33 μm, a Vₘₐₓ in the range of from about 390 to about 480 mm³/g, a total soda content of less than about 0.2 wt. %, an electrical conductivity in the range of less than about 100 μS/cm, a soluble soda content in the range of from 0.001 to less than 0.02 wt %, based on the dry-milled ATH particles, a non-soluble soda content in the range of from about 70 to about 99.8% of the total soda content of the dry-milled ATH and a thermal stability, determined by thermogravimetric analysis, as described in Table 1:
TABLE 1

| 1 wt. % TGA (° C.) | 2 wt. % TGA (° C.) |
|---|---|
| 210-225 | 220-235 |

or
b) a BET in the range of from about 6 to about 9 m²/g, a d₅₀ in the range of from about 1.3 to about 2.0 μm, an oil absorption in the range of from about 25 to about 40%, an r₅, in the range of from about 0.185 to about 0.325 μm, a Vₘₐₓ in the range of from about 400 to about 600 mm³/g, a total soda content of less than about 0.3 wt. %, an electrical conductivity in the range of less than about 150 μS/cm, a soluble soda content in the range of from 0.001 to less than 0.03 wt %, based on the dry-milled ATH particles, a non-soluble soda content in the range of from about 70 to about 99.8% of the total soda content of the dry-milled ATH and a thermal stability, determined by thermogravimetric analysis, as described in Table 2:
TABLE 2

| 1 wt. % TGA (° C.) | 2 wt. % TGA (° C.) |
|---|---|
| 200-215 | 210-225 |

or
c) a BET in the range of from about 9 to about 15 m²/g and a d₅₀ in the range of from about 0.9 to about 1.8 μm, an oil absorption in the range of from about 25 to about 50%, an r₅₀ in the range of from about 0.09 to about 0.21 μm, a Vₘₐₓ in the range of from about 300 to about 700 mm³/g, a total soda content of less than about 0.4 wt. %, an electrical conductivity in the range of less than about 200 μS/cm, a soluble soda content in the range of from 0.001 to less than 0.04 wt %, based on the dry-milled ATH particles, a non-soluble soda content in the range of from about 70 to about 99.8% of the total soda content of the dry-milled ATH and a thermal stability, determined by thermogravimetric analysis, as described in Table 3:
TABLE 3

| 1 wt. % TGA (° C.) | 2 wt. % TGA (° C.) |
|---|---|
| 195-210 | 205-220 |

41. The flame retarded polymer formulation according to claim 40 wherein said dry-milled ATH particles have:
a) a soluble soda content of less than about 0.1 wt. %, based on the ATH particles in the slurry or filter cake; or
b) a non-soluble soda content in the range of from about 70 to about 99 wt. % of the total soda content with the remainder being soluble soda; or
c) combinations of a) and b).

42. A molded or extruded article made from the flame retarded polymer formulation according to claim 37.
